(19) United States
(12) Patent Application Publication
(10) Pub. No.: US 2022/0188956 A1
(43) Pub. Date: Jun. 16, 2022

(54) ELECTRONIC APPARATUS FOR MANAGING TRANSPORTING ITEM ON FULFILLMENT CENTER AND INFORMATION MANAGING METHOD THEREOF

(71) Applicant: Coupang Corp., Seoul (KR)

(72) Inventors: Jong Won Lee, Seoul (KR); Min Seo Kim, Seoul (KR); Sang Min Jun, Seoul (KR); Sun Young Hong, Seoul (KR); Woo Jung Park, Seoul (KR)

(21) Appl. No.: 17/171,880

(22) Filed: Feb. 9, 2021

(30) Foreign Application Priority Data
Dec. 16, 2020 (KR) 10-2020-0176772

(51) Int. Cl. G06Q 50/28; G06Q 10/06

(52) U.S. Cl. CPC G06Q 50/28; G06Q 10/06315

(57) ABSTRACT

According to the present disclosure, an information managing method of an electronic apparatus for managing transportation of an item from a fulfillment center to another fulfillment center is disclosed, wherein the method includes acquiring transportation request information of items arranged in the fulfillment center, checking a collection priority for each of the items related to the transportation request information based on at least one of the transportation request information and status information of the item arranged in the fulfillment center, and generating collection information based on the checked priority.

### BACKGROUND

### Technical Field

The present disclosure relates to an electronic device for managing transportation of items from a fulfillment center to another fulfillment center and an information managing method thereof.

### Description of the Related Art

With the development of electronic technology, e-commerce has become a common type of shopping. A customer may purchase an item online without going to a shopping mall or market directly, and the item purchased online is delivered to a delivery destination requested by the customer.

In the case of such an e-commerce transaction, because a speed of item delivery has a significant impact on service satisfaction, various ways to deliver items to customers more quickly are being discussed. As one method for such rapid delivery, fulfillment centers are being provided in various regions. Each fulfillment center stores a variety of items sold online, and when an item is purchased, delivery is made to a customer who has purchased the item at a fulfillment center near the customer. That is, a delivery period is shortened by placing items in various regions before the items are purchased and then shipping the items from a fulfillment center adjacent to a customer's location when the purchase occurs.

On the other hand, since the quantity of items delivered to customers for each fulfillment center is not constant, a fulfillment center (or replenishment center) that serves to properly replenish inventory to the fulfillment center may be provided. Since the delivery from another fulfillment center to customers is smoothly performed only when items are appropriately transported from a fulfillment center serving as a replenishment center to another fulfillment center, there is a need for a method of effectively managing a fulfillment center serving as a replenishment center.

### SUMMARY

### Technical Goals

The present disclosure is directed to providing an electronic apparatus capable of efficiently transporting items from a fulfillment center to another fulfillment center by using collection information generated according to collection priority for each item, and a control method thereof.

The technical problems to be achieved by the embodiments of the present disclosure are not limited to the technical problems described above, and other technical problems may be inferred from the following embodiments.

### Technical Solutions

According to an aspect of the present disclosure, there is provided an information managing method of an electronic apparatus for managing transportation of an item from a fulfillment center to another fulfillment center, the information managing method including: acquiring transportation request information of the item arranged in the fulfillment center; checking a collection priority for each item related to the transportation request information based on at least one of the transportation request information and status information of the item arranged in the fulfillment center; and generating collection information based on the checked priority.

According to another aspect of the present disclosure, there is provided a computer-readable non-transitory recording medium on which a program allowing a computer to execute the information managing method of the electronic apparatus for managing transportation of an item from a fulfillment center to another fulfillment center is recorded, the information managing method including: acquiring transportation request information of the item arranged in the fulfillment center; checking a collection priority for each item related to the transportation request information based on at least one of the transportation request information and status information of the item arranged in the fulfillment center; and generating collection information based on the checked priority.

According to still another aspect of the present disclosure, there is provided an electronic apparatus for managing transportation of an item from a fulfillment center to another fulfillment center, the electronic apparatus including: a memory storing an instruction; and a processor, wherein the processor is connected to the memory to acquire transportation request information of an item arranged in the fulfillment center; check a collection priority for each item related to the transportation request information based on at least one of the transportation request information and status information of the item arranged in the fulfillment center; and generate collection information based on the checked priority.

### Effects

An electronic apparatus for managing transportation of an item from a fulfillment center to another fulfillment center and information managing method thereof is capable of efficiently transporting items by using collection information generated according to collection priority for each item.

### BRIEF DESCRIPTION OF THE DRAWINGS

FIG. 1 is a functional block diagram of an electronic apparatus for managing transportation of items according to an embodiment;

FIG. 2 is a flowchart of an information managing method of an electronic apparatus for managing transportation of items according to an embodiment;

FIG. 3 is a diagram for describing a case in which the electronic apparatus according to the embodiment selects whether items are urgent based on a user input;

FIG. 4 is a diagram for describing an example of information on or regarding whether items are urgent provided by the electronic apparatus according to the embodiment;

FIG. 5 is a diagram for describing an example of collection status information of items provided by the electronic apparatus according to the embodiment;

FIGS. 6 and 7 are diagrams for describing an example of information provided to transport items collected by the electronic apparatus according to the embodiment;

FIG. 8 is a diagram for describing an example of collection status information and transportation status information for a specific tote provided by the electronic apparatus according to the embodiment; and

FIG. 9 is a diagram for describing an example of the transportation status information provided by the electronic apparatus according to the embodiment.

### DETAILED DESCRIPTION

General terms that are currently widely used are selected as terms used in embodiments in consideration of functions in the present disclosure but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise specified, “including” any component means that other components may be further included rather than excluding other components.

The expression “at least one of a, b, and c” described throughout the specification may include “a alone,” “b alone,” “c alone,” “a and b,” “a and c,” “b and c,” or “all of a, b, and c”.

An electronic apparatus described below may refer to an electronic apparatus, which may be implemented as a computer or a portable terminal capable of accessing a server or another electronic apparatus through a network. Here, computers may include, for example, a notebook, a desktop, a laptop, and the like, which are equipped with a web browser, and portable terminals are wireless communication devices that ensure portability and mobility, and may include, for example, International Mobile Telecommunications (IMT), code division multiple access (CDMA), W-code division multiple access (W-CDMA), or Long Term Evolution (LTE) terminals, and all kinds of handheld-based wireless communication devices, such as a smartphone and a tablet PC.

Hereinafter, embodiments of the present disclosure will be described in detail with reference to the accompanying drawings so that those skilled in the art to which the present disclosure pertains may easily practice the present disclosure. However, the present disclosure may be implemented in various different forms, and is not limited to the embodiments described herein.

Hereinafter, embodiments of the present disclosure will be described in detail with reference to the accompanying drawings.

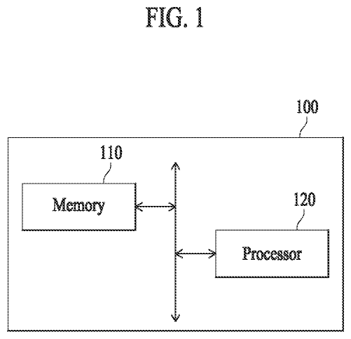

FIG. 1 is a functional block diagram of an electronic apparatus for managing transportation of items according to an embodiment. Although components related to the present embodiment are illustrated in FIG. 1, the present disclosure is not limited thereto, and other general-purpose components may be further provided in addition to the components illustrated in FIG. 1.

Referring to FIG. 1, an electronic apparatus 100 may include a memory 110 and a processor 120. Each element illustrated in FIG. 1 is a unit that processes at least one function or operation which may be implemented by hardware, software, or a combination of hardware and software.

According to an embodiment, the electronic apparatus 100 of FIG. 1 may be implemented as a server, a computer, or a terminal, and the present specification is not limited by the implementation method of the electronic apparatus 100.

The memory 110 may store various types of data related to the electronic apparatus 100. For example, the memory 110 may store at least one instruction for an operation of the electronic apparatus 100. In this case, the processor 120 to be described below may perform various operations based on the instruction stored in the memory 110.

In an embodiment, the memory 110 may store information on or regarding an item located in a fulfillment center. For example, the memory 110 may store information on or regarding at least one of a quantity, a name, a receipt timing, a price, an expiration date, a display location in a fulfillment center, and a company name of an item received in the fulfillment center. However, the information is not limited thereto, and various types of information related to the items may be stored.

In some cases, items may be arranged in units of groups within the fulfillment center. For example, 100 first items may be grouped and arranged at a specific location in units of groups. In this case, the memory 110 may store information on or regarding the number of grouped items and the arrangement location of items.

The processor 120 may control the overall operation of the electronic apparatus 100. For example, the processor 120 may control the operation of the electronic apparatus 100 by controlling elements of the electronic apparatus 100 based on the instruction stored in the memory 110.

The processor 120 may acquire transportation request information of the items arranged in the fulfillment center. For example, the processor 120 may acquire transportation request information in response to receiving transportation request information from another apparatus. The transportation request information is information on or regarding at least one item to be transported and may include, for example, information on or regarding at least one of a name, a quantity, and a transportation deadline of transportation items for each transportation target center. However, this is only an example, and the present embodiment is not limited thereto.

Meanwhile, the transportation target center is another fulfillment center to which the items arranged in the fulfillment center are transported, and the transportation request information may include information on or regarding a plurality of transportation target centers. In this case, the transportation request information may include the information on or regarding the name, quantity, and transportation deadline of items that are to be transported to each of the plurality of transportation target centers.

In some cases, the processor 120 may acquire the transportation request information based on a user input. For example, the transportation request information may be implemented as a file of a specific format, and in this case, the processor 120 may acquire the transportation request information based on a file that a user uploads.

The processor 120 may check the collection priority for each item related to the transportation request information based on at least one of the transportation request information and status information of the items arranged in the fulfillment center. The collection priority may include, for example, information on which items are to be collected first when collecting (or picking) the items to be transported from a location where the items are arranged in the fulfillment center.

In this case, since the collection priorities are checked for each item, in some cases, an item corresponding to a specific priority among the checked collection priorities may include a plurality of items that need to be transported to a plurality of fulfillment centers. For example, a first item confirmed to have a first priority may include items that need to be transported to a first center and a second center.

In an embodiment, the processor 120 may check a removal instruction date for each item. The processor 120 may check the collection priority for the item based on a difference between the checked removal instruction date and a current time (or a time at which the transportation request information is received). Here, the removal instruction date may include a predetermined date so that the item is removed from the fulfillment center. Information associated with a control instruction date may be previously stored in the memory 110.

In an embodiment, the processor 120 may check a transportation deadline for each item included in the transportation request information. The processor 120 may check the collection priority for the item based on the difference between the checked transportation deadline and the current time.

For example, the processor 120 may confirm that a collection priority for an item whose difference between the checked transportation deadline (or removal instruction date) and the current time is less than or equal to a predetermined number of days is a first priority. Specifically, for example, the processor 120 may confirm that the transportation deadline is November 21 in the case of the first item and the transportation deadline is November 23 in the case of the second item. When the current time is confirmed to be November 19, the processor 120 may check the difference between the current time and the transportation deadline for each item. The processor 120 may confirm that a collection priority for an item whose difference between the transportation deadline and the current time is less than or equal to a predetermined number of days (for example, 3 days) is a first priority. In this case, the processor 120 may confirm that the collection priority for the first item is the first priority.

As another example, the processor 120 may confirm that a collection priority for an item having the least difference between the checked transportation deadline (or removal instruction date) and the current time is a first priority. For example, when the transportation deadline of the first item is November 21, the transportation deadline of the second item is November 23, and the current time is November 20, the processor 120 may confirm that the collection priority for the first item having the least difference between the current time and the transportation deadline is a first priority.

Meanwhile, the transportation deadline is a deadline by which transportation is requested and may include, for example, information associated with a specific date.

In an embodiment, the processor 120 may check the transportation request quantity for each item included in the transportation request information and a remaining quantity for each item related to the transportation request information arranged in the fulfillment center. The processor 120 may confirm that a collection priority for an item whose remaining quantity corresponds to the transportation request quantity among the items related to the transportation request information is a second priority. When no first priority is confirmed, the second priority may correspond to a highest priority.

For example, the processor 120 may confirm that the collection priority for the first item is the second priority when the transportation request quantity of the first item is 100 and the remaining quantity of the first item arranged in the fulfillment center is 100. In this case, the remaining quantity may correspond to the remaining quantity of the first item arranged at the same location.

In some cases, the first item may be arranged at a plurality of locations within the fulfillment center. In this case, the remaining quantity may be checked for each of the plurality of locations, and the processor 120 may check the collection priority based on individually comparing the remaining quantity of each of the plurality of locations with the transportation request quantity. For example, when the transportation request quantity of the first item is confirmed to be 100 in the state in which 80 first items are arranged at a first location and 90 first items are arranged at a second location, 100 items are not arranged at the first location, and therefore it may not correspond to the second priority, and 100 items are not arranged at the second location either, and therefore it may not correspond to the second priority.

According to such an embodiment, the processor 120 may assign the second priority to the items arranged at a specific location and collected in a batch to preferentially collect the items. In this case, the utilization of the fulfillment center may be improved by effectively utilizing the space of the fulfillment center, and the collection efficiency may be improved by performing the collection at once.

In an embodiment, the processor 120 may check the transportation request quantity for each item included in the transportation request information and the remaining quantity for each item related to the transportation request information arranged in the fulfillment center. The processor 120 may confirm that a collection priority for an item whose remaining quantity is less than the transportation request quantity among the items related to the transportation request information is a third priority.

For example, the processor 120 may confirm that the collection priority for the first item is the third priority when the transportation request quantity of the first item is 100 and the remaining quantity of the first item arranged in the fulfillment center is 80. In this case, the remaining quantity may correspond to the remaining quantity of the first item arranged at the same location.

In some cases, the remaining quantity may be checked for each of the plurality of locations, and the processor 120 may check the collection priority based on individually comparing the remaining quantity of each of the plurality of locations with the transportation request quantity. For example, when the transportation request quantity of the first item is confirmed to be 100 in the state in which 80 first items are arranged at the first location and 130 first items are arranged at the second location, the collection priority for the first item arranged at the first location may be confirmed to be the third priority.

In an embodiment, the processor 120 may check the transportation request quantity for each item included in the transportation request information and the remaining quantity for each item related to the transportation request information arranged in the fulfillment center. The processor 120 may confirm that a collection priority for an item whose remaining quantity is greater than the transportation request quantity among the items related to the transportation request information is a fourth priority.

For example, the processor 120 may confirm that the collection priority for the first item is the fourth priority when the transportation request quantity of the first item is 100 and the remaining quantity of the first item arranged in the fulfillment center is 120. In this case, the remaining quantity may correspond to the remaining quantity of the first item arranged at the same location. In some cases, the remaining quantity may be checked for each of the plurality of locations. In this case, as described above, the processor 120 may check the collection priority based on individually comparing the remaining quantity of each of the plurality of locations with the transportation request quantity.

In an embodiment, the processor 120 may check an expiration date, a manufacturing date, or an arrangement period in a fulfillment center of each item related to the transportation request information arranged in the fulfillment center. The processor 120 may check a priority for each item related to transportation request information arranged in the fulfillment center based on the checked expiration date, manufacturing date, or arrangement period in the fulfillment center. For example, the processor 120 may check the collection priority in order from the earliest expiration date or the earliest manufacturing date of each item arranged in the fulfillment center. That is, the processor 120 may set a priority for an item with an early expiration date or an early manufacturing date to a higher priority. As another example, the processor 120 may check the collection priority in order from the longest arrangement period in the fulfillment center for each item. That is, the processor 120 may set a priority for an item with a long arrangement period in a fulfillment center to a higher priority.

In an embodiment, the collection priority may be sequentially checked for the above-described first to fifth priorities. In the collection priority, the first priority may be the highest priority, and the second to fifth priorities may sequentially correspond to subsequent priorities. Accordingly, the order of collection for each item included in the transportation request information may be determined. In this case, information may be sequentially provided to a terminal of a worker performing collection based on the order of collection, and as a result, the collection may be efficiently performed based on the collection priority.

In an embodiment, the processor 120 may check whether each item related to transportation request information is urgent. For example, when the transportation request information is received, the processor 120 may check whether each item included in the transportation request information is urgent.

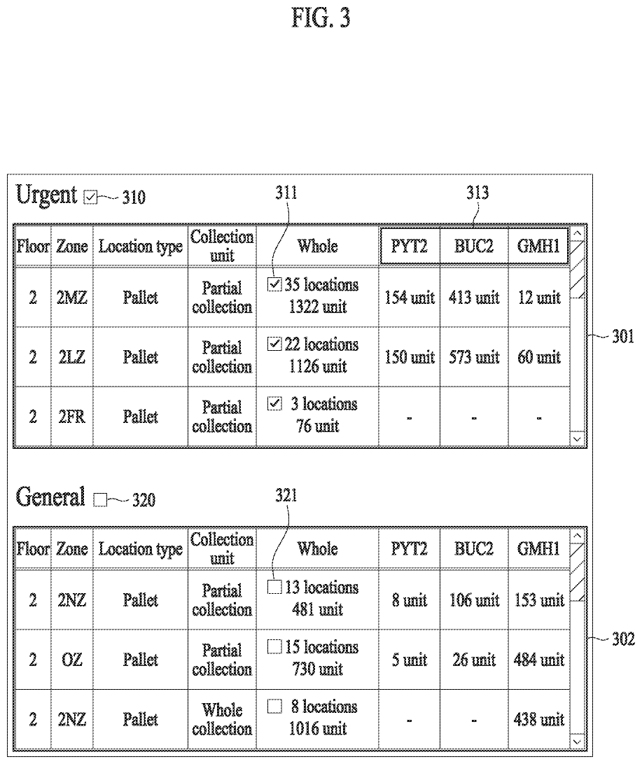

In an embodiment, the processor 120 may check whether each item is urgent based on a user input. For example, the processor 120 may receive a user input for selecting an urgent item from a list of all items included in the transportation request information. The processor 120 may determine that an item for which a user input is received is urgent. A more specific example related thereto will be described with reference to FIG. 3.

As another example, the processor 120 may check whether each item is urgent based on at least one of the quantity of the items related to the transportation request information arranged in another fulfillment center, the type of the items related to the transportation request information, whether an event related to the items related to the transportation request information is in progress, and a sales volume of the item related to the transportation request information.

For example, the processor 120 may check the quantity in the transportation destination fulfillment center of the item included in the transportation request information. For example, when the first item is included in the transportation request information and the fulfillment center to which the first item is transported is the first center, the processor 120 checks the information on or regarding the remaining quantity of the first item arranged in the first center. The processor 120 may determine that the first item is urgent when the remaining quantity of the first item is less than the predetermined number.

In another example, the processor 120 may check the type of items included in the transportation request information. For example, when the first item is included in the transportation request information, the processor 120 may check whether the type of the first item is the first type (for example, fresh food). When the type of the first item is the first type, the processor 120 may determine that the first item is urgent.

As another example, the processor 120 may check whether the event related to the item related to the transportation request information is in progress. For example, when the first item is included in the transportation request information, the processor 120 may check whether the event related to the first item is in progress. Here, the event may include, but is not limited to, for example, a discount event of the first item, and the event information may be acquired from another apparatus (for example, an online site operating server related to item sales). When the event related to the first item is in progress, the processor 120 may determine that the first item is urgent.

In an embodiment, the processor 120 may perform collection based on the collection priority for items determined to be urgent, and perform collection based on the collection priority for the remaining items. In this case, the collection priority may be checked after it is determined whether items are urgent, but it is not limited thereto and these may be performed in any order.

In an embodiment, the processor 120 may generate the collection information based on the checked priority (or collection priority). The collection information may include, for example, the information on the arrangement and quantity of items to be collected in the fulfillment center. However, the present disclosure is not limited thereto, and may be implemented to include various types of information for collecting items.

The processor 120 may transmit the generated collection information to the terminal. Here, the terminal may include at least one terminal connected to the electronic apparatus 100. The terminal may include, but is not limited to, a terminal possessed by a worker working in the fulfillment center, and may be implemented as, for example, a computer or a terminal of an administrator that is arranged in the fulfillment center.

In an embodiment, the terminal may be arranged at a predetermined location within the fulfillment center to manage the receipt and delivery of items arranged in a specific area. In this case, in response to the provision of the collection information to the terminal, the terminal may collect (or pick) an item corresponding to the provided collection information. Items may be collected using various methods such as a robot or a conveyor, but the prevent disclosure is not limited thereto. When items are picked using a robot or conveyor, the terminal may control the picking operation based on the connection with the robot or conveyor.

In some cases, when the terminal is an apparatus possessed by a worker, the worker may request to pick an item corresponding to carry-out information based on the provision of the carry-out information to the terminal.

In an embodiment, the terminal may obtain information on or regarding a tote. The tote may include a kind of basket in which items to be collected are contained, and more specifically, for example, may include a transportation-only tote provided to be used in a transportation destination fulfillment center or a common tote of all fulfillment centers. The information on or regarding the tote may include, for example, information on or regarding whether the tote is the transportation-only tote or the common tote for all fulfillment centers, and information on or regarding at least one of the type of items that may be contained in the tote and the quantity of items that may be contained in the tote. However, the present disclosure is not limited thereto, and the tote used for collection may be a dedicated tote for the distribution center. In this case, the tote compatibility based on the common tote may be ensured based on the transportation of the item to the common tote in the distribution step that will be described below.

In an embodiment, the tote may be checked in various ways. For example, the tote may be checked based on recognizing barcode information previously attached to the tote by the terminal. As another example, the tote may be checked based on recognizing the tote using a sensor included in the terminal.

In an embodiment, the terminal may transmit the information on or regarding the checked tote to the processor 120 in response to acquiring the information on or regarding the tote. The processor 120 may store the information on or regarding the transmitted tote and check the collection status of the tote based on communication with the terminal.

In an embodiment, the terminal may acquire location-related information inside a fulfillment center. For example, the terminal may acquire location-related information based on a user input. As another example, the terminal may acquire location-related information indicated by a barcode based on recognizing the barcode attached to a specific location in a fulfillment center in which items are arranged. The location-related information indicated by the barcode may include information indicating the specific location within the fulfillment center to which the barcode is attached. In this case, the specific location within the fulfillment center may correspond to an area within a fulfillment center in which a user wants to perform the collection.

In an embodiment, upon acquiring the location-related information, the terminal may transmit the location-related information to the processor 120. A plurality of areas may be included in the fulfillment center, and an area in which collection is to be performed among the plurality of areas may be checked based on the checking of the location-related information.

In an embodiment, the processor 120 may provide collection target information to the terminal based on location-related information. The collection target information may include information (for example, the quantity of items) on items to be included in a tote in an area of a fulfillment center corresponding to location-related information.

In some cases, the processor 120 may provide the collection target information to the terminal based on the information on or regarding the tote and the location-related information. The information on or regarding the tote may include, for example, information associated with the quantity of items that may be contained in the tote or the type of items that may be contained in the tote. In this case, the collection target information may include, for example, information on the quantity of items to be contained in the tote among items included in the area of the fulfillment center corresponding to the location-related information. The items that may be contained in the tote may include, but are not limited to, for example, items smaller in size than the tote.

In an embodiment, the processor 120 may provide the collection target information based on the priority based on the determination of the collection priority. For example, the processor 120 may provide the collection target information to the terminal in order from information associated with items having high priority to information associated with items having low priority among the items checked based on at least one of the tote information and the location-related information. However, the present disclosure is not limited thereto, and for example, the processor 120 may provide information associated with items scheduled to be collected in the area of the fulfillment center corresponding to the location-related information and priority information together.

In an embodiment, the location-related information may include information associated with the location of the terminal. In this case, the processor 120 may acquire the location-related information indicating the location of the terminal based on the communication with the terminal. The processor 120 may provide, as collection target information, information associated with items having the highest collection priority among items located adjacent to the terminal using the location-related information.

In an embodiment, the processor 120 may receive a distribution request for the collection information generated from the terminal. Since the collected items may include items to be transported to a plurality of fulfillment centers in response to checking the collection priority for each item, the distribution request may be performed to distinguish the items to be transported.

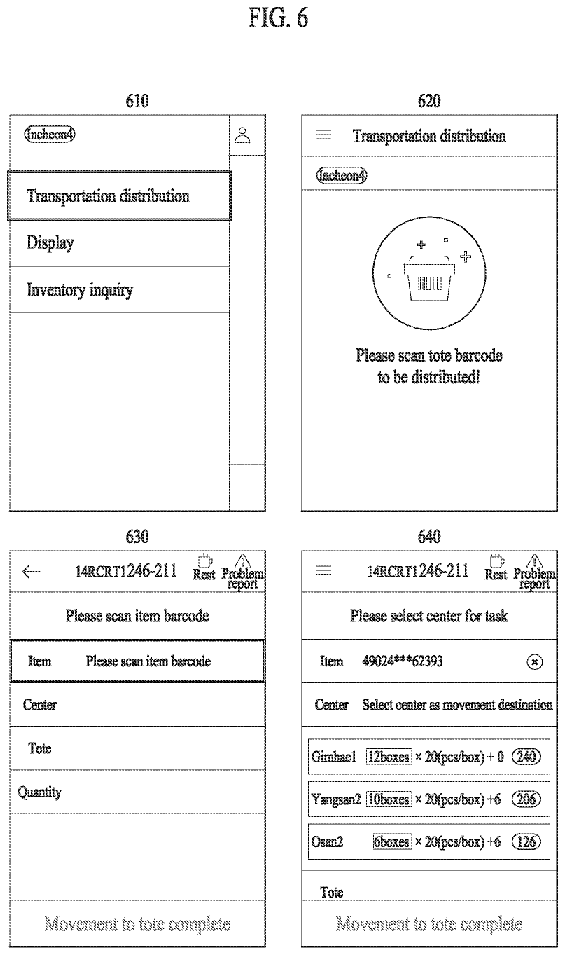

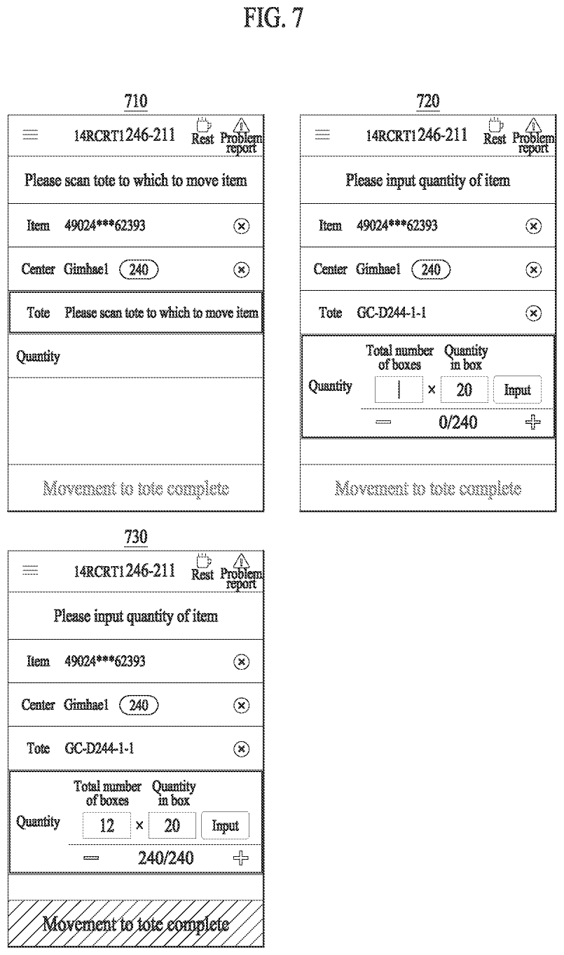

Specifically, the processor 120 may provide information on a fulfillment center to which items corresponding to the collection information are transported based on the transportation request information in response to receiving the distribution request. Here, the distribution may include an operation of distinguishing the collected items by each center, and the distribution request may include a request to distinguish the collected items for each center. Upon receiving the distribution request, the processor 120 may provide the information on the fulfillment center to which the items corresponding to the collection information are transported. FIGS. 6 and 7 may be referred to for a specific example related to this.

In an embodiment, the processor 120 may allocate a tote corresponding to a transportation destination fulfillment center. Here, the tote corresponding to the transportation destination fulfillment center may include a tote for distribution. For example, the processor 120 may allocate a first tote to a first center and a second tote to a second center, among the transportation destination fulfillment centers.

The processor 120 may provide the information associated with the items to be collected in the tote based on the transportation request information and the information on or regarding the allocated tote. For example, the processor 120 may check the transportation request information and the information on or regarding the allocated tote, and provide the terminal with the information on or regarding the allocated tote for each transportation destination fulfillment center which appears in the transportation request information. The terminal may distribute items to be collected to totes for each center based on the provided information. The totes containing the distributed items may be distinguished for each center, and thus the totes may be loaded onto a transportation device (for example, a transport vehicle) moving to a corresponding center and moved to the transportation destination fulfillment center corresponding to the tote.

In an embodiment, the processor 120 may transmit the information associated with the loaded tote to an electronic apparatus corresponding to a transportation destination fulfillment center. Specifically, when the tote is loaded, the processor 120 may receive a response indicating completion of loading from the terminal. Upon receiving the response from the terminal, the processor 120 may transmit the information associated with the loaded tote to the electronic apparatus corresponding to the transportation destination fulfillment center. In some cases, the information associated with the loaded tote may be transmitted from the terminal to the electronic apparatus corresponding to the transportation destination fulfillment center. When the information associated with the loaded tote is checked by the electronic apparatus of the transportation destination fulfillment center, the transportation status of the item corresponding to the tote may be changed. In this case, the changed transportation status may correspond to the status managed by the electronic apparatus in the fulfillment center, but is not limited thereto and may be applied to other apparatuses connected to the electronic apparatus.

Here, the electronic apparatus corresponding to the transportation destination fulfillment center may include an electronic apparatus implemented as at least one of a computer, a terminal, and a server installed in the transportation destination fulfillment center. The apparatus of the transportation destination fulfillment center may check the received information. The apparatus of the transportation destination fulfillment center may change the transportation status of the item corresponding to the tote of the transportation destination fulfillment center in response to checking information associated with the loaded tote.

Meanwhile, in an embodiment, the transportation status of the item may be managed by a central server. The central server may manage information on a center from which items are taken out and a center to which items are transported, the center from which the items are taken out may provide information on collection of items to a worker, the worker may collect items into a tote based on the provided information, and the collected tote may be loaded and moved to the transportation target center. When the worker of the transportation target center checks the information associated with the loaded tote through the terminal, the server may change the transportation status from the center from which the items contained in the tote are taken out to the transportation target center. In order to facilitate the transportation of the items in this way, the collection information may be provided to the worker, and the worker may collect items into a tote corresponding to a specific center based on the collection information, transport the collected tote to the transportation target center through a transport means, and manage the movement of the items in units of totes, thus simplifying the procedure for a means of transportation.

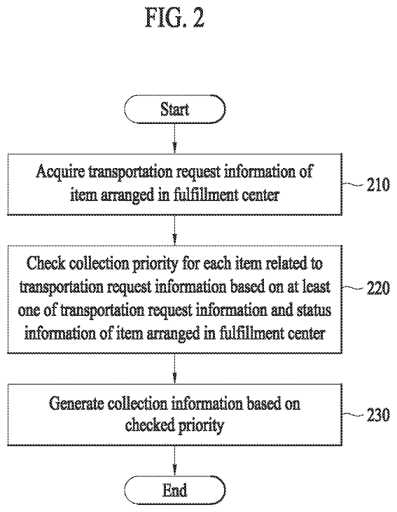

FIG. 2 is a flowchart of an information managing method of an electronic apparatus for managing transportation of items according to an embodiment. Each operation of the method illustrated in FIG. 2 may be performed in a different order from that illustrated in the drawings in some cases. Hereinafter, content overlapping that described in FIG. 1 may be omitted.

Referring to FIG. 2, in operation 210, the electronic apparatus may acquire transportation request information of items arranged in a fulfillment center. The transportation request information is information on or regarding items that need to be transported to another fulfillment center among items arranged within the fulfillment center, and may include information on or regarding at least one of the name, quantity, and transportation deadline of an item to be transported, and the fulfillment center to which each item is to be transported.

In an embodiment, the electronic apparatus may acquire the transportation request information from another apparatus. However, the present disclosure is not limited thereto, and the transportation request information may be generated by the electronic apparatus based on a user input.

In an embodiment, the electronic apparatus may check whether each item included in the acquired transportation request information is urgent. Whether each item is urgent may be checked based on, for example, the user input, or whether each item is urgent may be determined based on status information of items of a transportation destination fulfillment center corresponding to the items.

For example, the electronic apparatus may check whether each item is urgent based on at least one of the quantity of the items related to the transportation request information arranged in another fulfillment center, the type of the items related to the transportation request information, whether the event related to the items related to the transportation request information is in progress, and a sales volume of the item related to the transportation request information. When a specific item needs to be transported to a plurality of fulfillment centers and when at least one fulfillment center satisfies the conditions corresponding to the urgency, the item may be confirmed to be urgent.

In operation 220, the electronic apparatus may check a collection priority for each item related to the transportation request information based on at least one of the transportation request information and the status information of the items arranged in the fulfillment center. The collection priority may indicate a priority of items to be preferentially collected among the items to be transported. In this case, since the collection priorities are checked for each item, in some cases, an item corresponding to a specific priority among the checked collection priorities may include a plurality of items that need to be transported to a plurality of fulfillment centers. For example, first items confirmed to have a first priority may include items that need to be transported to a first center and a second center.

In an embodiment, upon acquiring the transportation request information, the electronic apparatus may check status information of an item corresponding to a transportation target item included in transportation request information arranged in a fulfillment center. The status information may include, for example, information on or regarding at least one of the quantity, expiration date, manufacturing date, and arrangement period (or storage period) of items arranged in the fulfillment center at the current time.

Here, the quantity of items arranged in the fulfillment center may include the quantity for each arrangement location (or arrangement unit, or arrangement area) within the fulfillment center. Specifically, when the same item is distributed and arranged at different locations within the fulfillment center, the quantity of items arranged within the fulfillment center may be distinguished at each location. In this case, the collection priority may also be checked based on the arrangement location. That is, when the same item is distributed and arranged at different locations, it is possible to determine whether or not the item satisfies a reference quantity at each location. For example, the electronic apparatus may check the collection priority based on comparing the quantity of items required by the transportation request information with the quantity of items arranged in the fulfillment center. In comparing the quantity of items, when the same items are arranged at different locations, these items are not added up, and the collection priority may be checked based on comparing the quantity of items arranged at each location, for example, the first location with the quantity of items requested by the transportation request information, and comparing the quantity of items arranged at the second location with the quantity of items requested by the transportation request information.

The electronic apparatus may check a collection priority based on at least one of a difference between the removal instruction date for each item included in the transportation request information and a current time, a difference between a transportation deadline for each item and the current time, a transportation request quantity and an expiration date for each item in a fulfillment center, a transportation request quantity and a manufacturing date for each item in a fulfillment center, and a transportation request quantity and a storage period for each item in a fulfillment center.

For example, the electronic apparatus may determine, as a first priority, a collection priority of an item whose difference between a removal instruction date for each item included in the transportation request information and a current time is less than a predetermined number of days (for example, 3 days). However, the present disclosure is not limited thereto, and in some cases, the electronic apparatus may determine, as the first priority, the collection priority of the item whose difference between a predetermined transportation deadline instead of the removal instruction date and a current time is less than a predetermined number of days (for example, 3 days).

In addition, the electronic apparatus may determine the second to fourth priorities according to whether the items can be collected in a batch. Specifically, the electronic apparatus may determine an item whose transportation request quantity corresponds to an arrangement quantity to have a second priority, an item whose transportation request quantity is greater than an arrangement quantity to have a third priority, and an item whose transportation request quantity is smaller than an arrangement quantity to have a fourth priority based on comparing the transportation request quantity with the arrangement quantity for each item in the fulfillment center. In addition, the electronic apparatus determines a fifth priority based on the expiration date, the manufacturing date, or the arrangement period in the fulfillment center. Specifically, the electronic apparatus may assign detailed priorities in order from the earliest expiration date, the earliest manufacturing date, or the longest arrangement period in a fulfillment center to perform the collection according to the priorities.

On the other hand, when there are no items corresponding to a priority, the priorities may increase sequentially. For example, when there is no item corresponding to the first priority, the second priority may be the highest priority.

In operation 230, the electronic apparatus may generate collection information based on priority. For example, the electronic apparatus may generate collection information by assigning priority information to items to be collected. The generated collection information may be transmitted to a terminal of a worker who performs collection. In this case, items to be collected and priority information may be displayed on the terminal together. Accordingly, a worker may perform the collection according to the priority.

As another example, the electronic apparatus may generate collection information to provide information on or regarding items corresponding to the next priority after the information on or regarding the items to be collected is preferentially collected according to the priority.

In an embodiment, the electronic apparatus may receive a distribution request. Upon receiving the distribution request, the electronic apparatus may check at least one fulfillment center to which the item corresponding to the collection information is transported. The electronic apparatus may provide the information on at least one checked fulfillment center. Accordingly, the collected items may be distinguished for each transportation destination fulfillment center.

FIG. 3 is a diagram for describing a case in which the electronic apparatus according to the embodiment selects whether items are urgent based on a user input.

Referring to FIG. 3, the electronic apparatus may display the transportation request information differently based on the arrangement area of the item. The arrangement area of the item is indicated by zone in FIG. 3, and the arrangement unit within the arrangement area is indicated by location but is not limited by these terms. In an embodiment, collection may be performed in units of locations, collection priority may be checked for locations included in an area in which an urgent decision to be described below is made, and collection may be performed according to priority.

In an embodiment, the electronic apparatus may receive an input for selecting items in various ways to determine whether items are urgent. For example, all items included in an urgent area 301 may be selected based on an input to a first check box 310 for selecting items displayed in the urgent area 301 at once. In some cases, as illustrated, an urgent item may be selected based on an input to a check box (for example, a second check box 311) provided for each item.

In an embodiment, the electronic apparatus may receive a selection input of a general item. For example, all items included in a general area 302 may be selected based on an input to a third check box 320 for selecting items displayed in the general area 302 at once. In some cases, as illustrated, a general item may be selected based on an input to a check box (for example, a fourth check box 321) provided for each item. General items are distinguished from urgent items and may include items that are collected after urgent items are collected.

According to FIG. 3, the electronic apparatus may provide information 313 on a fulfillment center to which an item is transported, but the present disclosure is not limited thereto.

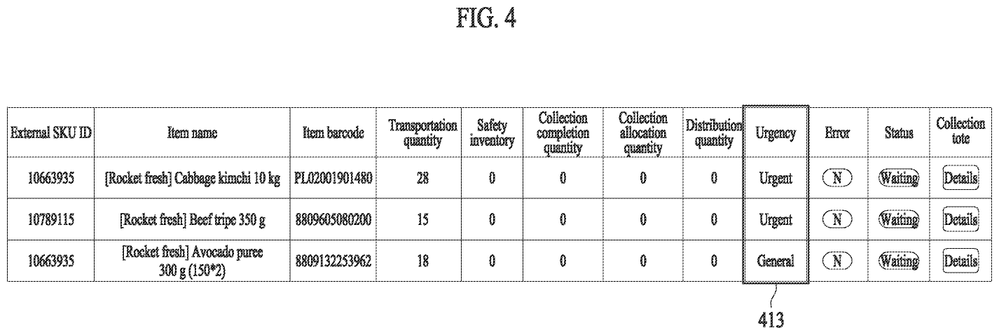

FIG. 4 is a diagram for describing an example of information on whether items are urgent provided by the electronic apparatus according to the embodiment.

Referring to FIG. 4, the electronic apparatus may display information on whether each item is urgent. The information on whether the items are urgent may be displayed in a first area 413. The items determined as urgent items may be indicated as “urgent,” and other items may be indicated as “general.”

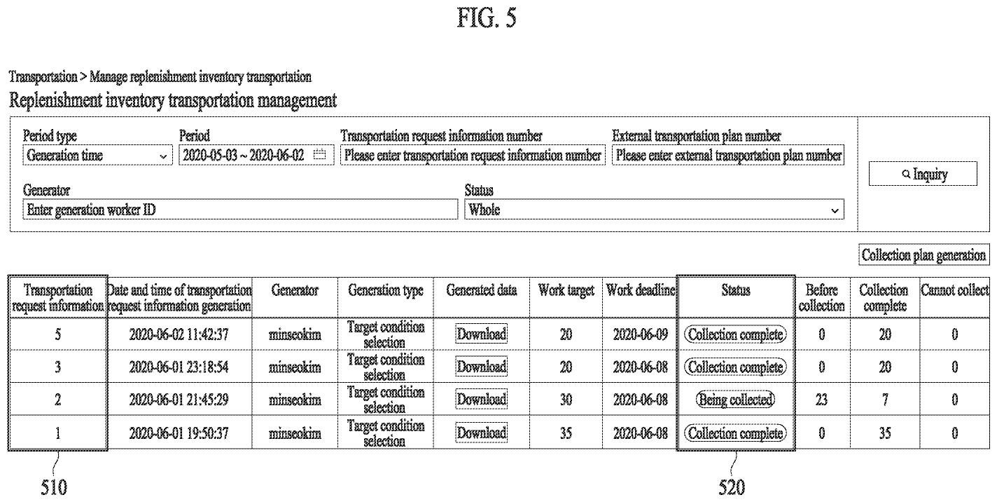

FIG. 5 is a diagram for describing an example of collection status information of the transportation request information provided by the electronic apparatus according to the embodiment.

Referring to FIG. 5, upon acquiring a plurality of pieces of transportation request information, the electronic apparatus may provide information on or regarding a collection status for each piece of transportation request information. The transportation request information may be displayed in a first area 510 and the collection status may be displayed in a second area 520, but the present disclosure is not limited thereto. In addition, the collection status may include, but is not limited to, “collection complete” or “being collected” as illustrated, and may be expressed in various forms indicating the status.

FIGS. 6 and 7 are diagrams for describing an example of information provided to transport items collected by the electronic apparatus according to the embodiment. Specifically, FIGS. 6 and 7 illustrate an example of a screen provided through the terminal connected to the electronic apparatus.

Reference numeral 610 of FIG. 6 denotes an example of a screen in which a distribution request is received through the terminal based on the completion of collection. In response to an input to a transportation distribution item indicated by reference number 610, the terminal may receive a distribution request. The terminal may transmit the received distribution request to the electronic apparatus.

Reference number 620 denotes an example of a screen requesting recognition of a tote containing the collected items. A barcode may be attached to the tote, and the terminal may check the tote based on recognition of the barcode attached to the tote.

When the tote is checked, a screen like reference numeral 630 may be provided. Reference number 630 may be a screen for requesting checking of the item on which the collection has been completed, that is, checking of the item included in the tote in which the collection has been completed. The item may be checked based on the recognition of the barcode attached to the item. In this case, when the barcode of the item is recognized, the information mapped to the previously recognized tote information on what items are contained in the tote may be provided to the electronic apparatus.

In an embodiment, the collected item may be an item that needs to be transported to a plurality of transportation target fulfillment centers. In this case, a screen for selecting a transportation target fulfillment center to which a tote (or item to be contained in the tote) is transported may be displayed as illustrated by reference number 640.

FIG. 7 illustrates a screen provided after the transportation destination fulfillment center is selected in reference numeral 640 of FIG. 6. Specifically, reference number 710 may be a screen displayed when one of the plurality of transportation destination fulfillment centers, for example, center “Gimhae 1,” is selected.

When a tote containing items to be transported to the selected transportation destination fulfillment center is scanned while a screen like reference number 710 is displayed, the tote information may be recognized and displayed in a tote column as illustrated by reference number 720.

Reference number 720 may be a screen for requesting input of the quantity of items to be contained in the tote to be transported to the transportation destination fulfillment center. A screen like reference number 730 is provided based on the quantity input, and the distribution of the tote to the selected transportation destination fulfillment center may be completed based on an input of a “movement to tote complete” button of reference number 730. If there is no space in the tote and the quantity contained in the tote is less than the transportation request quantity, additional distribution may be performed.

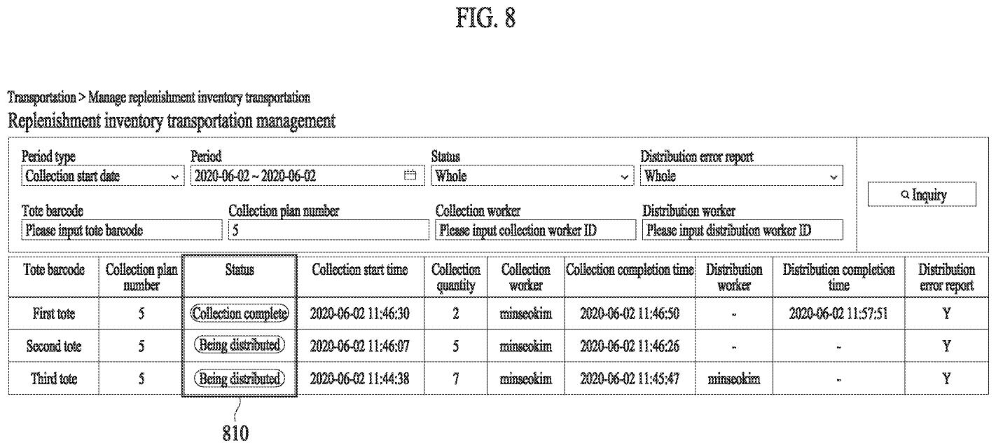

FIG. 8 is a diagram for describing an example of collection status information and transportation status information for a specific tote provided by the electronic apparatus according to the embodiment.

Referring to FIG. 8, the electronic apparatus may provide information on or regarding a distribution status for each tote containing the collected items. For example, when collection of a first item to a first tote is performed, collection of a second item to a second tote is performed, and collection of a third item to a third tote is performed, after the collection is completed for each tote, the information on or regarding the distribution status may be displayed.

In an embodiment, the electronic apparatus may update the information on or regarding the distribution status in real time based on response information received from the terminal. In this case, the distribution status of the second item or the third item currently displayed as “being distributed” may be changed.

In addition, in some cases, an error may occur in the distribution. In this case, information “Y” is provided as illustrated in the distribution error report, so that a user may understand the error situation.

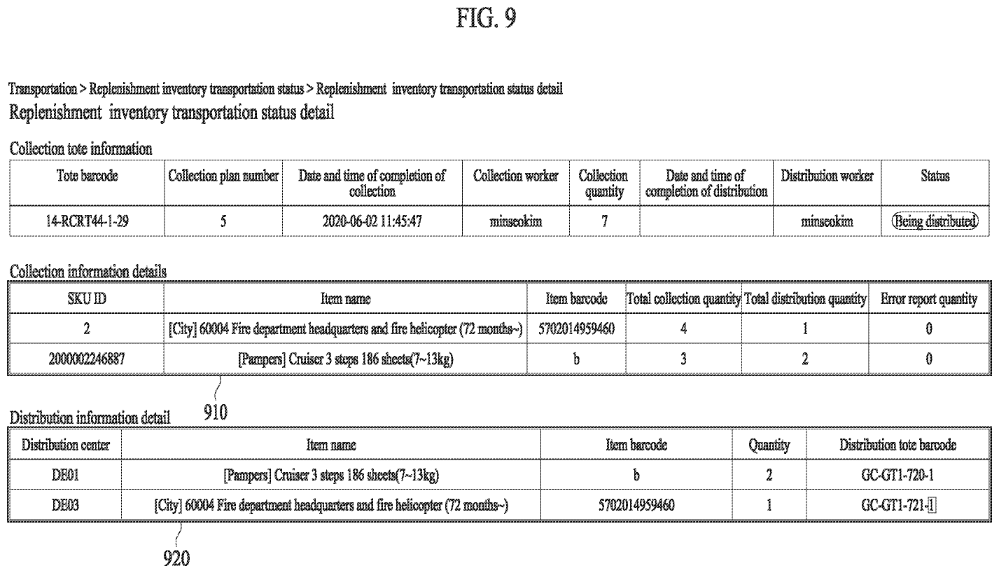

FIG. 9 is a diagram for describing an example of the transportation status information provided by the electronic apparatus according to the embodiment.

Referring to FIG. 9, the electronic apparatus may provide information on or regarding a collection status and a distribution status corresponding to the transportation request information. The collection status may be displayed in a first area 910 and the distribution status may be displayed in a second area 920.

Information on or regarding the quantity of each item collected completely may be displayed in the first area 910, and as illustrated, the information on or regarding the quantity of distribution may also be displayed by reflecting the distribution status. However, the present disclosure is not limited thereto, and the collection status may be displayed in various ways.

Information indicating the distribution status of each center (for example, DEO1, DEO3) for items that have been collected completely may be displayed in the second area 920.

In an embodiment, a tote used for collection and distribution in response to the transportation request information may correspond to a common tote commonly used without distinguishing between fulfillment centers. In some cases, as the tote used for the collection, not only a common tote, but also a fulfillment-center-only tote for performing the collection may be used.

The electronic apparatus or terminal according to the above-described embodiments may include a processor, a memory that stores and executes program data, a permanent storage such as a disk drive, a communication port that communicates with an external device, a touch panel, a key, a user interface device such as a button, and the like. Methods implemented as software modules or algorithms may be stored on a computer-readable recording medium as computer-readable codes or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disc (CD)-ROM or a digital versatile disc (DVD)), and the like. The computer-readable recording medium may be distributed in computer systems connected to each other through a network, and as a result, the computer-readable codes may be stored in a distributed scheme and executed. The medium may be readable by a computer, stored in a memory, and executed on a processor.

The present embodiment may be represented by functional block configurations and various processing steps. These functional blocks may be implemented by various numbers of hardware and/or software components that execute specific functions. For example, the embodiment may employ integrated circuit configurations, such as a memory, processing, logic, and a look-up table, capable of executing various functions by control of one or more microprocessors or other control devices. Similar to executing the components in software programming or software elements, the present embodiment can be implemented in programming or scripting languages such as python, C, C++, Java, and assembler, including various algorithms implemented by a combination of data structures, processes, routines or other programming configurations. Functional aspects may be implemented in algorithms executed on one or more processors. In addition, the present embodiment may employ a conventional technology for electronic environment setting, signal processing, and/or data processing, and the like. Terms such as “mechanism,” “element,” “means,” and “configuration” may be used widely, and are not limited to mechanical and physical configurations. The terms may include the meaning of a series of routines of software in connection with a processor or the like.

According to the present disclosure, in an electronic apparatus for managing transportation of items from a fulfillment center to another fulfillment center and an information managing method thereof, the collection information generated according to the collection priority for each item is used to perform the collection for the transportation of items, thereby more efficiently performing the transportation of items to the fulfillment center.

Effects of the present disclosure are not limited to the above-described effects, and other effects that are not described will be clearly understood by those skilled in the art from the description of the scope of the claims. The above-described embodiments are merely examples, and other embodiments may be implemented within the scope of the following claims.

1. A method for managing transportation of an item from a fulfillment center to another fulfillment center, the method comprising:
controlling, by a processor of a computing device, a communication port of the computing device to communicate with a user terminal and a worker terminal;
receiving, from the user terminal by the communication port of the computing device, transportation request information of one or more items arranged in the fulfillment center;
determining, by the processor of the computing device, a collection priority for each of the one or more items related to the transportation request information based on at least one of the transportation request information or status information of the one or more items arranged in the fulfillment center;
determining, by the processor of the computing device, urgency information by determining whether each of the one or more items is an urgent item;
generating, by the processor of the computing device, collection information based on the collection priority and the urgency information;
transmitting, by the communication port of the computing device, to the worker terminal, the collection information, wherein the collection information comprises information describing an arrangement and quantity of items to be collected; and
causing transportation of the one or more items in an order based on the collection priority,
wherein the urgent item comprises an item to be collected before collection of items according to the collection priority,
wherein the determining of whether each of the one or more items is urgent comprises checking whether each of the one or more items is urgent based on at least one of a quantity of an item related to the transportation request information arranged in the another fulfillment center, a type of the item related to the transportation request information, whether an event related to the item related to the transportation request information is in progress, and a sales volume of the item related to the transportation request information,
wherein the urgency is based on at least one of remain of the quantity of an item related to the transportation request information arranged in the another fulfillment center less than predetermined number, the type of the item related to fresh item, and the discount event related to the item.

2. The method of claim 1, further comprising:
acquiring, from the worker terminal, information associated with a tote;
acquiring, from the worker terminal, location-related information inside the fulfillment center; and
providing collection target information to the worker terminal based on the information associated with the tote and the location-related information.

3. The method of claim 1, further comprising:
allocating a tote corresponding to a transportation destination fulfillment center; and
providing status information of one or more items to be collected in the tote based on the transportation request information and information associated with the tote,
wherein the tote is configured to be loaded and moved to the transportation destination fulfillment center.

4. The method of claim 3, wherein a transportation status of the one or more items to be collected in the tote is changed in response to information associated with the tote, wherein the tote is checked by an electronic apparatus of the transportation destination fulfillment center.

5. The method of claim 1, wherein the determining of the collection priority includes:
checking a transportation deadline or a removal instruction date for each of the one or more items related to the transportation request information; and
determining that the collection priority for an item corresponding to a difference between the transportation deadline or the removal instruction date and a current time that is less than or equal to a predetermined number of days among the one or more items related to the transportation request information comprises a first priority.

6. The method of claim 1, wherein the determining of the collection priority includes:
checking a transportation request quantity for each of the one or more items related to the transportation request information and a remaining quantity for each of the one or more items related to the transportation request information and arranged in the fulfillment center; and
determining that the collection priority for an item corresponding to a remaining quantity that corresponds to the transportation request quantity among the one or more items related to the transportation request information comprises a second priority.

7. The method of claim 1, wherein the determining of the collection priority includes:
checking a transportation request quantity for each of the one or more items related to the transportation request information and a remaining quantity for each of the one or more items related to the transportation request information and arranged in the fulfillment center; and
determining that the collection priority for an item corresponding to a remaining quantity that is less than the transportation request quantity among the one or more items related to the transportation request information comprises a third priority.

8. The method of claim 1, wherein the determining of the collection priority includes:
checking a transportation request quantity for each of the one or more items related to the transportation request information and a remaining quantity for each of the one or more items related to the transportation request information and arranged in the fulfillment center; and
determining that the collection priority for an item corresponding to a remaining quantity that is greater than the transportation request quantity among the one or more items related to the transportation request information comprises a fourth priority.

9. The method of claim 1, wherein the determining of the collection priority includes:
checking one of:
an expiration date or a manufacturing date for each of the one or more items related to the transportation request information and arranged in the fulfillment center, or
an arrangement period in the fulfillment center; and
determining the collection priority for each of the one or more items related to the transportation request information and arranged in the fulfillment center based on the expiration date or manufacturing date.

10. The method of claim 1, wherein the determining of the collection priority for each of the one or more items comprises checking the collection priority based on at least one of the transportation request information or the status information of the of the one or more items arranged in the fulfillment center for at least one item whose urgency is checked among the one or more items related to the transportation request information.

11. The method of claim 10, wherein whether each of the one or more items is urgent is determined based on a user input.

13. The method of claim 1, further comprising:
receiving, from the worker terminal, a distribution request for the collection information; and
in response to receiving the distribution request, providing information associated with the another fulfillment center to which the item corresponding to the collection information is to be transported based on the transportation request information in response to receiving the distribution request.

14. A computer-readable non-transitory recording medium on which a program allowing a computer to execute the method of claim 1 is recorded.

15. A computing device for managing transportation of an item from a fulfillment center to another fulfillment center, the computing device comprising:
a memory that stores an instruction; and
a processor, wherein the processor is connected to the memory to:
control a communication port of the computing device to communicate with a user terminal and a worker terminal;
receive, from the user terminal, transportation request information of one or more items arranged in the fulfillment center;
determine a collection priority for each of the one or more items related to the transportation request information based on at least one of the transportation request information or status information of the one or more items arranged in the fulfillment center;
determine urgency information by determining whether each of the one or more items is an urgent item;
generate collection information based on the collection priority and the urgency information;
transmit, by the communication port of the computing device to the worker terminal, the collection information, wherein the collection information comprises information describing an arrangement and quantity of items to be collected; and
cause transportation of the one or more items in an order based on the collection priority,
wherein the urgent item comprises an item to be collected before collection of items according to the collection priority,
wherein the determining of whether each of the one or more items is urgent comprises checking whether each of the one or more items is urgent based on at least one of a quantity of an item related to the transportation request information arranged in the another fulfillment center, a type of the item related to the transportation request information, whether an event related to the item related to the transportation request information is in progress, and a sales volume of the item related to the transportation request information,
wherein the urgency is based on at least one of remain of the quantity of an item related to the transportation request information arranged in the another fulfillment center less than predetermined number, the type of the item related to fresh item, and the discount event related to the item.
